(19) United States
(12) Patent Application Publication
(10) Pub. No.: US 2022/0121226 A1
(43) Pub. Date: Apr. 21, 2022

(54) INFORMATION PROCESSING APPARATUS, INFORMATION PROCESSING SYSTEM, NON-TRANSITORY COMPUTER READABLE MEDIUM, AND VEHICLE

(71) Applicant: TOYOTA JIDOSHA KABUSHIKI KAISHA, Toyota-shi Aichi-ken (JP)

(72) Inventors: Tae Sugimura, Miyoshi-shi Aichi-ken (JP); Kenta Miyahara, Toyota-shi Aichi-ken (JP); Shin Sakurada, Toyota-shi Aichi-ken (JP); Roger Kyle, Nagoya-shi Aichi-ken (JP)

(73) Assignee: TOYOTA JIDOSHA KABUSHIKI KAISHA, Toyota-shi Aichi-ken (JP)

(21) Appl. No.: 17/501,522

(22) Filed: Oct. 14, 2021

(30) Foreign Application Priority Data
Oct. 16, 2020 (JP) 2020-174942

(51) Int. Cl. G05D 1/10; B64C 39/02; G06Q 10/08

(52) U.S. Cl. CPC G05D 1/1062; B64C 39/024; G06Q 10/083; B64C 2201/208; B64C 2201/128; B64C 2201/14; B64C 2201/027

(57) ABSTRACT

An information processing apparatus includes a controller. The controller is configured to acquire travel information including a travel route for when the vehicle travels and determine, based on the acquired travel information, transfer information for when a delivery item to be delivered by an unmanned aircraft to a user on board the vehicle is transferred to the user.

### CROSS-REFERENCE TO RELATED APPLICATION

This application claims priority to Japanese Patent Application No. 2020-174942, filed on Oct. 16, 2020, the entire contents of which are incorporated herein by reference.

### TECHNICAL FIELD

The present disclosure relates to an information processing apparatus, an information processing system, a program, and a vehicle.

### BACKGROUND

Technology is known for delivering delivery items to a predetermined delivery destination, such as a residence, using an unmanned aircraft such as a drone. For example, patent literature (PTL) 1 discloses a delivery system in which delivery packages along with a drone are mounted on a delivery vehicle, and the delivery vehicle travels to a plurality of delivery areas.

### CITATION LIST

### Patent Literature

PTL 1: JP 2016-153337 A

### SUMMARY

With known technology, however, a drone-based delivery service is provided to delivery destinations, such as residences, that have fixed positional information. There is room for improvement in such technology in terms of a user in a traveling vehicle receiving a delivery item from an unmanned aircraft.

The present disclosure provides technology that enables a user in a traveling vehicle to receive a delivery item from an unmanned aircraft.

An information processing apparatus according to an embodiment of the present disclosure is an information processing apparatus including a controller configured to: acquire travel information including a travel route for when a vehicle travels, and determine, based on the acquired travel information, transfer information for when a delivery item to be delivered by an unmanned aircraft to a user on board the vehicle is transferred to the user.

A program according to an embodiment of the present disclosure is configured to cause an information processing apparatus to: acquire travel information including a travel route for when a vehicle travels, and determine, based on the acquired travel information, transfer information for when a delivery item to be delivered by an unmanned aircraft to a user on board the vehicle is transferred to the user.

A vehicle according to an embodiment of the present disclosure is a vehicle including a controller configured to: acquire travel information including a travel route for when the vehicle travels, and determine, based on the acquired travel information, transfer information for when a delivery item to be delivered by an unmanned aircraft to a user on board the vehicle is transferred to the user.

An information processing apparatus, an information processing system, a program, and a vehicle according to embodiments of the present disclosure enable a user on board a traveling vehicle to receive a delivery item from an unmanned aircraft.

### BRIEF DESCRIPTION OF THE DRAWINGS

In the accompanying drawings:

FIG. 1 is a configuration diagram illustrating a configuration of an information processing system that includes an information processing apparatus according to an embodiment of the present disclosure;

FIG. 2 is a functional block diagram illustrating schematic configurations of the information processing apparatus, a vehicle, a terminal apparatus, and an unmanned aircraft of FIG. 1;

FIG. 3 is a sequence diagram illustrating an example of an information processing method performed by the information processing system of FIG. 1;

FIG. 4 is a flowchart illustrating a first example of an information processing method performed by the information processing apparatus of FIG. 1;

FIG. 5 is a flowchart illustrating a second example of an information processing method performed by the information processing apparatus of FIG. 1;

FIG. 6 is a flowchart illustrating a third example of an information processing method performed by the information processing apparatus of FIG. 1;

FIG. 7 is a flowchart illustrating a fourth example of an information processing method performed by the information processing apparatus of FIG. 1; and

FIG. 8 is a diagram illustrating an example of processing by the controller of the information processing apparatus of FIG. 2.

### DETAILED DESCRIPTION

Embodiments of the present disclosure will be described below, with reference to the drawings.

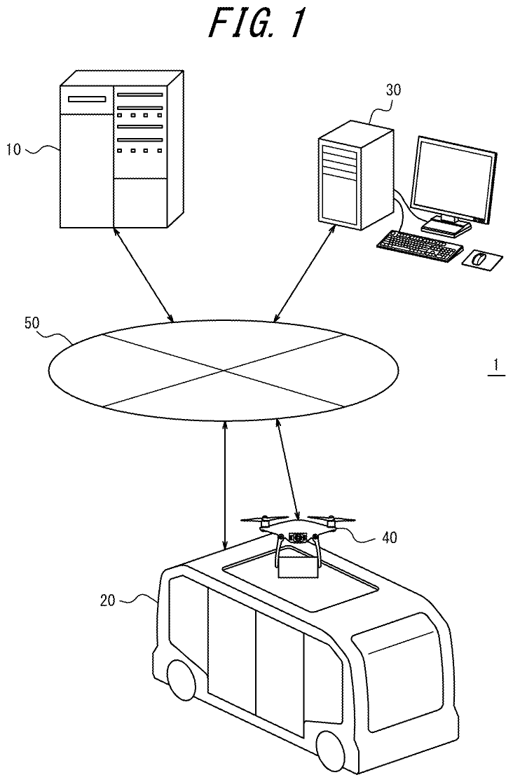

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to the embodiment of the present disclosure will be primarily described. The information processing system 1 includes a vehicle 20, a terminal apparatus 30, and an unmanned aircraft 40, in addition to the information processing apparatus 10.

For the sake of explanation, only one of each of the information processing apparatus 10, the vehicle 20, the terminal apparatus 30, and the unmanned aircraft 40 is illustrated in FIG. 1, but the number of information processing apparatuses 10, vehicles 20, terminal apparatuses 30, and unmanned aircraft 40 may be two or more of each. The information processing apparatus 10, the vehicle 20, the terminal apparatus 30, and the unmanned aircraft 40 are each communicably connected to a network 50, examples of which include a mobile communication network and the Internet.

The information processing apparatus 10 is a single server apparatus or a plurality of server apparatuses that can communicate with each other. The information processing apparatus 10 is not limited to these, and may be any general purpose electronic device such as a personal computer (PC) or a smartphone, or may be any other electronic device that is dedicated to the information processing system 1.

The vehicle 20 is, for example, an automobile. The vehicle 20 is not limited to this and may be any vehicle on which a person can board to drive to a destination. The vehicle 20 is, for example, a vehicle that performs autonomous driving. The autonomous driving may include any level from Level 1 to Level 5 as defined by the Society of Automotive Engineers (SAE), for example, but is not limited to these, and may be defined in any way. The vehicle 20 is not limited to a vehicle that performs autonomous driving and may be any vehicle driven by a driver.

The terminal apparatus 30 is, for example, a general purpose electronic device such as a PC or a smartphone. The terminal apparatus 30 is, for example, an electronic device managed by a service provider that provides delivery items to users on board a traveling vehicle 20. The terminal apparatus 30 is not limited to these examples and may be one server apparatus, or a plurality of server apparatuses that can communicate with each other, managed by the service provider. The terminal apparatus 30 may also be a dedicated electronic device for the information processing system 1.

In the present disclosure, the “service provider” includes any provider that provides services related to home delivery, food and beverage, retail, or the like. In the present disclosure, the “delivery item” includes, for example, any product ordered for delivery by a user on board the vehicle 20 while the vehicle 20 is traveling or before the vehicle 20 departs from its departure point. In the present disclosure, the “product” includes, for example, food and/or beverages sold by a restaurant for delivery and any other products sold on a website, such as an electronic commerce (EC) site. These examples are not limiting, and the delivery item may, for example, include a package sent from any sender as an express package to a user on board the vehicle 20.

The unmanned aircraft 40 is any aircraft without a person on board. The unmanned aircraft 40 includes aircraft such as drones and multicopters. The unmanned aircraft 40 is capable of flying by autonomous control or by cooperating with the information processing apparatus 10. The unmanned aircraft 40 is used for delivery services to deliver delivery items to users in the vehicle 20. For example, in response to a request from a user who wishes to receive a delivery item, a predetermined unmanned aircraft 40 is selected by the information processing apparatus 10 to transfer the delivery item. The unmanned aircraft 40 travels to the point where delivery items are prepared by the service provider and receives the delivery item. The unmanned aircraft 40 then flies to the delivery point for the vehicle 20, enabling the user to receive the delivery item from the selected unmanned aircraft 40 even while traveling in the vehicle 20.

As an overview of an embodiment, the information processing apparatus 10 acquires travel information including a travel route when the vehicle 20 travels. In the present disclosure, the “travel information” includes, for example, a travel route to a predetermined destination set by a user, on board the vehicle 20, using a car navigation device or the like. Additionally, the travel information may, for example, include the current positional information for the vehicle 20 and the travel speed of the vehicle 20. Based on the acquired travel information, the information processing apparatus 10 determines transfer information for when the delivery item, to be delivered by the unmanned aircraft 40 to the user on board the vehicle 20, is transferred to the user.

In the present disclosure, the “transfer information” includes, for example, information related to the transfer of a delivery item, from the unmanned aircraft 40 to the vehicle 20, when the delivery item is delivered by the unmanned aircraft 40 to a user on board the vehicle 20. The transfer information includes, for example, the scheduled delivery time and the delivery point. Additionally, the transfer information includes, for example, control information for the unmanned aircraft 40 and/or control information for the vehicle 20 for mechanically transferring the delivery item.

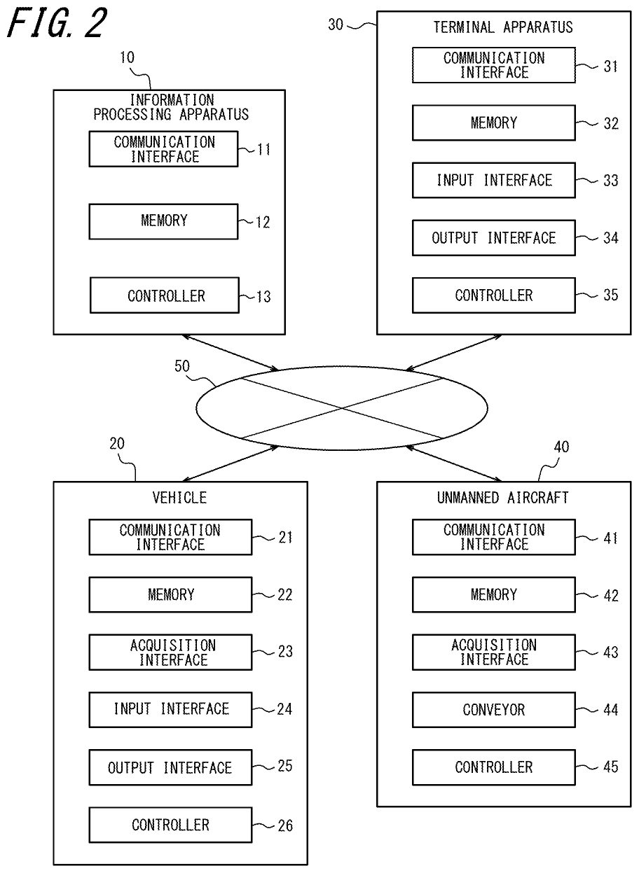

Next, referring to FIG. 2, configurations of the information processing apparatus 10, the vehicle 20, the terminal apparatus 30, and the unmanned aircraft 40 included in the information processing system 1 are primarily described. FIG. 2 is a functional block diagram illustrating schematic configurations of the information processing apparatus 10, the vehicle 20, the terminal apparatus 30, and the unmanned aircraft 40 of FIG. 1.

As illustrated in FIG. 2, the information processing apparatus 10 includes a communication interface 11, a memory 12, and a controller 13.

The communication interface 11 includes a communication module connected to the network 50. For example, the communication interface 11 may include a communication module compliant with mobile communication standards such as the 4th generation (4G) and the 5th generation (5G) standards or with Internet standards. In an embodiment, the information processing apparatus 10 is connected to the network 50 via the communication interface 11. The communication interface 11 transmits and receives various information via the network 50.

The memory 12 is, for example, a semiconductor memory, a magnetic memory, an optical memory, or the like, but is not limited to these. The memory 12 may function as, for example, a main memory, an auxiliary memory, or a cache memory. The memory 12 stores any information used in operation of the information processing apparatus 10. For example, the memory 12 may store a system program, an application program, various types of information received or transmitted by the communication interface 11, and the like. Information stored in the memory 12 may be updated with, for example, information received from the network 50 via the communication interface 11.

The controller 13 includes at least one processor. The “processor” is a general purpose processor or a dedicated processor that is dedicated to specific processing in an embodiment but is not limited to these. The controller 13 is communicably connected to each component included in the information processing apparatus 10 and controls operation of the entire information processing apparatus 10.

Next, the configuration of the vehicle 20 included in the information processing system 1 is mainly described. As illustrated in FIG. 2, the vehicle 20 includes a communication interface 21, a memory 22, an acquisition interface 23, an input interface 24, an output interface 25, and a controller 26. The communication interface 21, the memory 22, the acquisition interface 23, the input interface 24, the output interface 25, and the controller 26 are communicably connected to each other via an in-vehicle network, such as a Controller Area Network (CAN), or a dedicated line.

The communication interface 21 includes a communication module connected to the network 50. For example, the communication interface 21 may include a communication module compliant with mobile communication standards such as the 4G and the 5G standards. In an embodiment, the vehicle 20 is connected to the network 50 via the communication interface 21. The communication interface 21 transmits and receives various information via the network 50.

The memory 22 is, for example, a semiconductor memory, a magnetic memory, an optical memory, or the like, but is not limited to these. The memory 22 may function as, for example, a main memory, an auxiliary memory, or a cache memory. The memory 22 stores any data used in the operation of the vehicle 20. For example, the memory 22 may store a system program, an application program, various types of information received or transmitted by the communication interface 21, and the like. Information stored in the memory 22 may be updated with, for example, information received from the network 50 via the communication interface 21.

The acquisition interface 23 includes any module capable of acquiring a travel route to a predetermined destination set by a user on board the vehicle 20, traffic information on the travel route, and the like. For example, the acquisition interface 23 includes a module forming part of a car navigation device.

The acquisition interface 23 includes at least one receiver compliant with any appropriate satellite positioning system. For example, the acquisition interface 23 may include a Global Positioning System (GPS) receiver. The acquisition interface 23 acquires a measured value of the position of the vehicle 20 as the positional information. The positional information includes, for example, an address, a latitude, a longitude, an altitude, and the like. The acquisition interface 23 may acquire the positional information for the vehicle 20 continually, periodically, or non-periodically.

The input interface 24 includes, for example, at least one input interface that accepts an input operation by an occupant in a cabin of the vehicle 20 and acquires input information based on the input operation by the occupant. For example, the input interface 24 includes an input interface that forms part of a car navigation device. For example, the input interface 24 includes a touchscreen integrated with a liquid crystal monitor that forms part of a car navigation device. The input interface 24 receives an input operation by the occupant based on a touch operation by the occupant, for example.

The input interface 24 is not limited to these examples and may include any input interface capable of detecting an input operation by an occupant and acquiring input information based on the input operation by the occupant. The input interface 24 may, for example, include a physical key, a capacitive key, or a microphone for receiving audio input.

The output interface 25 includes at least one output interface that outputs information to an occupant in the cabin of the vehicle 20. For example, the output interface 25 includes an output interface that forms part of a car navigation device. For example, the output interface 25 includes a liquid crystal monitor that forms part of a car navigation device. The output interface 25 outputs information by image and/or audio, for example.

The output interface 25 is not limited to these examples and may include any output interface that stimulates the sense of sight and/or hearing of an occupant of the vehicle 20. The output interface 25 may, for example, include any other audio output interface, other than a car navigation device, that primarily stimulates the sense of hearing of the occupant of the vehicle 20. The output interface 25 may, for example, include any other image output interface, other than a car navigation device, that primarily stimulates the sense of sight of the occupant of the vehicle 20.

The controller 26 includes at least one processor. For example, the controller 26 may include an electronic control unit (ECU). The controller 26 is communicably connected with the components of the vehicle 20 and controls operation of the entire vehicle 20.

Next, the configuration of the terminal apparatus 30 included in the information processing system 1 will be primarily described. As illustrated in FIG. 2, the terminal apparatus 30 includes a communication interface 31, a memory 32, an input interface 33, an output interface 34, and a controller 35.

The communication interface 31 includes a communication module connected to the network 50. For example, the communication interface 31 may include a communication module compliant with mobile communication standards such as the 4G and the 5G standards or Internet standards. In an embodiment, the terminal apparatus 30 is connected to the network 50 via the communication interface 31. The communication interface 31 transmits and receives various information via the network 50.

The memory 32 is, for example, a semiconductor memory, a magnetic memory, an optical memory, or the like, but is not limited to these. The memory 32 may function as, for example, a main memory, an auxiliary memory, or a cache memory. The memory 32 stores any information used for operations of the terminal apparatus 30. For example, the memory 32 may store a system program, an application program, various types of information received or transmitted by the communication interface 31, and the like. Information stored in the memory 32 may be updated with, for example, information received from the network 50 via the communication interface 31.

The input interface 33 includes at least one input interface for detecting user input to acquire input information based on an operation by the user. For example, the input interface 33 may includes a physical key, a capacitive key, a touchscreen integrally provided with a display of the output interface 34, or a microphone that receives audio input.

The output interface 34 includes at least one output interface for outputting information to notify the user of the information. The output interface 34 is, for example, a display for outputting information in image form, a speaker for outputting information in audio form, or the like, but is not limited to these.

The controller 35 includes at least one processor. The controller 35 is communicably connected to the components forming the terminal apparatus 30 and controls the operation of the entire terminal apparatus 30.

Next, the configuration of the unmanned aircraft 40 included in the information processing system 1 will be primarily described. As illustrated in FIG. 2, the unmanned aircraft 40 includes a communication interface 41, a memory 42, an acquisition interface 43, a conveyor 44, and a controller 45.

The communication interface 41 includes a communication module connected to the network 50. For example, the communication interface 41 may include a communication module compliant with mobile communication standards such as the 4G and the 5G standards. In an embodiment, the unmanned aircraft 40 is connected to the network 50 via the communication interface 41. The communication interface 41 transmits and receives various information via the network 50.

The memory 42 is, for example, a semiconductor memory, a magnetic memory, an optical memory, or the like, but is not limited to these. The memory 42 may function as, for example, a main memory, an auxiliary memory, or a cache memory. The memory 42 stores any information used for operations of the unmanned aircraft 40. For example, the memory 42 may store a system program, an application program, various types of information received or transmitted by the communication interface 41, and the like. Information stored in the memory 42 may be updated with, for example, information received from the network 50 via the communication interface 41.

The acquisition interface 43 includes at least one receiver compliant with any appropriate satellite positioning system. For example, the acquisition interface 43 may include a GPS receiver. The acquisition interface 43 acquires a measured value of the position of the unmanned aircraft 40 as the positional information. The positional information includes, for example, an address, a latitude, a longitude, an altitude, and the like. The acquisition interface 43 may acquire the positional information for the unmanned aircraft 40 continually, periodically, or non-periodically.

The conveyor 44 includes any conveying module capable of conveying a delivery item during flight from the point at which the delivery item is prepared by the service provider to the delivery point. The conveyor 44 includes, for example, a robotic arm capable of supporting the delivery item during flight of the unmanned aircraft 40. This example is not limiting, and the conveyor 44 may, for example, include a conveyor box attached to the body of the unmanned aircraft 40 and capable of storing the delivery item. The conveyor 44 may, for example, include any attaching module capable of attaching the delivery item to the body of the unmanned aircraft 40.

The controller 45 includes at least one processor. The controller 45 is communicably connected with the components forming the unmanned aircraft 40 and controls operation of the entire unmanned aircraft 40.

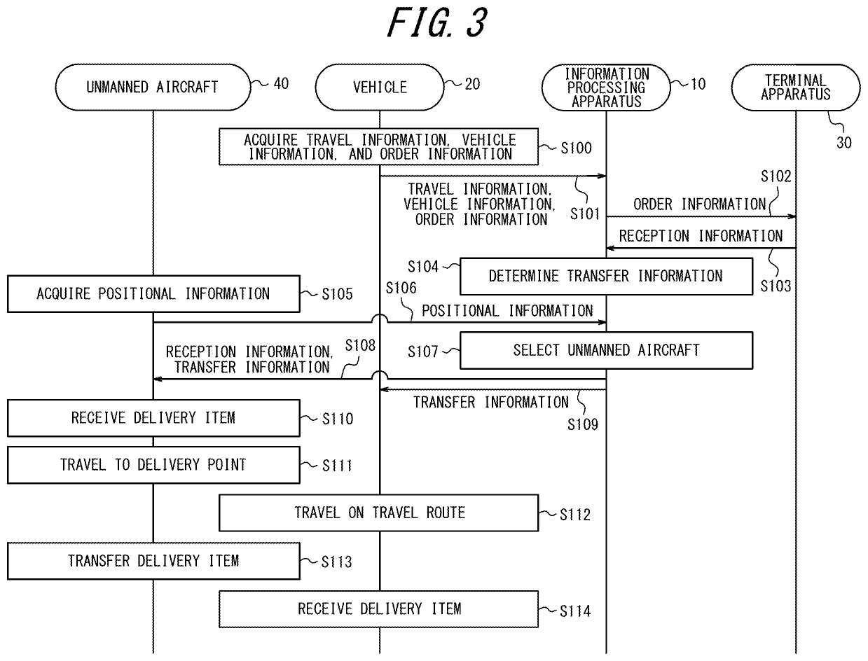

FIG. 3 is a sequence diagram illustrating an example of an information processing method performed by the information processing system 1 of FIG. 1. With reference to FIG. 3, an example of the information processing method performed by the information processing system 1 of FIG. 1 will be described. The sequence diagram in FIG. 3 illustrates an example of the basic processing flow in the information processing method performed by the information processing system 1.

In step S100, the controller 26 of the vehicle 20 acquires travel information including a travel route when the vehicle 20 travels. For example, the controller 26 acquires, from the acquisition interface 23, a travel route from the departure point to the destination point inputted at the departure point by the user, as an occupant, using the input interface 24. For example, the controller 26 acquires the current positional information for the vehicle 20 from the acquisition interface 23.

Additionally, the controller 26 acquires vehicle information for the vehicle 20 by, for example, by reading the vehicle information from the memory 22. In the present disclosure, the “vehicle information” includes, for example, the vehicle type and detailed structural information on the vehicle body. The “detailed structural information on the vehicle body” includes, for example, the arrangement, number, and structure of doors at the sides and rear of the vehicle body; the presence or absence, arrangement, number, and size of a sunroof; and the presence or absence, arrangement, number, and size of a reception box capable of receiving and storing delivery items from the unmanned aircraft 40.

Additionally, the controller 26 acquires order information for the delivery item. For example, the controller 26 acquires order information for the delivery item based on the content of a delivery order inputted by the user, as an occupant, using the input interface 24. In the present disclosure, the “order information” includes, for example, a list and amount of food and beverages based on a delivery order, and items and quantities of other products other than food and beverages.

In step S101, the controller 26 of the vehicle 20 transmits the travel information, the vehicle information, and the order information acquired in step S100 to the information processing apparatus 10 via the communication interface 21 and the network 50. The controller 13 of the information processing apparatus 10 acquires travel information including a travel route when the vehicle 20 travels. The controller 13 acquires the vehicle information for the vehicle 20. The controller 13 acquires the order information for the delivery item.

In step S102, the controller 13 of the information processing apparatus 10 transmits the order information for the delivery item acquired in step S101 to the terminal apparatus 30 via the communication interface 11 and the network 50. The controller 35 of the terminal apparatus 30 acquires the order information for the delivery item. The service provider that manages the terminal apparatus 30 then prepares the delivery item to be delivered to the user in the vehicle 20 based on the order information for the delivery item acquired by the terminal apparatus 30.

In step S103, the controller 35 of the terminal apparatus 30 transmits reception information, for when the unmanned aircraft 40 is to receive the delivery item prepared by the service provider from the service provider, to the information processing apparatus 10 via the communication interface 31 and the network 50. In the present disclosure, the “reception information” includes, for example, an available reception time, a reception point, and item information for the delivery item. In the present disclosure, the “item information” includes, for example, a list and amount of food and beverages prepared by the service provider, and items and quantities of other products other than food and beverages. In addition to this information, the reception information may, for example, include control information for the unmanned aircraft 40 to mechanically receive the delivery item. The controller 13 of the information processing apparatus 10 acquires the reception information.

In step S104, the controller 13 of the information processing apparatus 10 determines, based on the travel information acquired in step S101, the transfer information for when the delivery item, to be delivered by the unmanned aircraft 40 to the user on board the vehicle 20, is transferred to the user. In addition to the travel information, the controller 13 may at this time determine the transfer information based also on the vehicle information acquired in step S101 and/or the item information for the delivery item acquired in step S103.

In step S105, the controller 45 of the unmanned aircraft 40 acquires the current positional information for the unmanned aircraft 40 from the acquisition interface 43.

In step S106, the controller 45 of the unmanned aircraft 40 transmits the positional information acquired in step S105 to the information processing apparatus 10 via the communication interface 41 and the network 50. The controller 13 of the information processing apparatus 10 acquires the current positional information for the unmanned aircraft 40.

In step S107, the controller 13 of the information processing apparatus 10 selects a predetermined unmanned aircraft 40 from among at least one unmanned aircraft 40 included in the information processing system 1 as the unmanned aircraft 40 to be used for the delivery service. For example, the controller 13 may select any unmanned aircraft 40 that can arrive at the reception point by the available reception time included in the reception information acquired in step S103. For example, the controller 13 may select the unmanned aircraft 40 that is flying or standing by on the ground at the position closest to the reception point included in the reception information acquired in step S103.

In step S108, the controller 13 of the information processing apparatus 10 transmits the reception information acquired in step S103 and the transfer information determined in step S104 to the unmanned aircraft 40 selected in step S107 via the communication interface 11 and the network 50. The controller 45 of the unmanned aircraft 40 acquires the reception information and the transfer information. At this time, the controller 45 of the unmanned aircraft 40 may also acquire the travel information from the vehicle 20 and/or the information processing apparatus 10.

In step S109, the controller 13 of the information processing apparatus 10 transmits the transfer information determined in step S104 to the vehicle 20 via the communication interface 11 and the network 50. The controller 26 of the vehicle 20 acquires the transfer information.

In step S110, the controller 45 of the unmanned aircraft 40 controls the unmanned aircraft 40 so that, based on the reception information acquired in step S108, the unmanned aircraft 40 receives the delivery item prepared by the service provider. For example, the controller 45 controls the unmanned aircraft 40 so that the unmanned aircraft 40 travels to the reception point by the available reception time included in the reception information acquired in step S108. For example, the controller 45 may control the conveyor 44 at the reception point to receive the delivery item based on the control information included in the reception information acquired in step S108.

In step S111, the controller 45 of the unmanned aircraft 40 controls the unmanned aircraft 40 to travel to the delivery point, towards the vehicle 20 traveling on the travel route, after the unmanned aircraft 40 receives the delivery item in step S110.

In step S112, the controller 26 of the vehicle 20 controls the vehicle 20 so that the vehicle 20 travels on the travel route included in the travel information acquired in step S100. For example, the vehicle 20 may travel by autonomous driving along the travel route included in the acquired travel information or may assist the driver in driving the vehicle by indicating the travel route to the driver via the output interface 25.

In step S113, the controller 45 of the unmanned aircraft 40 controls the unmanned aircraft 40, based on the transfer information acquired in step S108, so that the unmanned aircraft 40 transfers the delivery item to the user on board the vehicle 20. For example, the controller 45 controls the unmanned aircraft 40 so that the unmanned aircraft 40 travels to the delivery point by the scheduled delivery time included in the transfer information acquired in step S108. For example, the controller 45 may control the conveyor 44 at the delivery point so that the unmanned aircraft 40 transfers the delivery item based on the control information included in the transfer information acquired in step S108.

In step S114, the controller 26 of the vehicle 20 controls the vehicle 20, based on the transfer information acquired in step S109, so that a user on board the vehicle 20 can receive the delivery item from the unmanned aircraft 40. For example, the controller 26 controls the vehicle 20 so that the vehicle 20 travels to the delivery point by the scheduled delivery time included in the transfer information acquired in step S109. For example, the controller 26 may control the vehicle 20 to receive the delivery item from the unmanned aircraft 40 at the delivery point based on the control information included in the transfer information acquired in step S109.

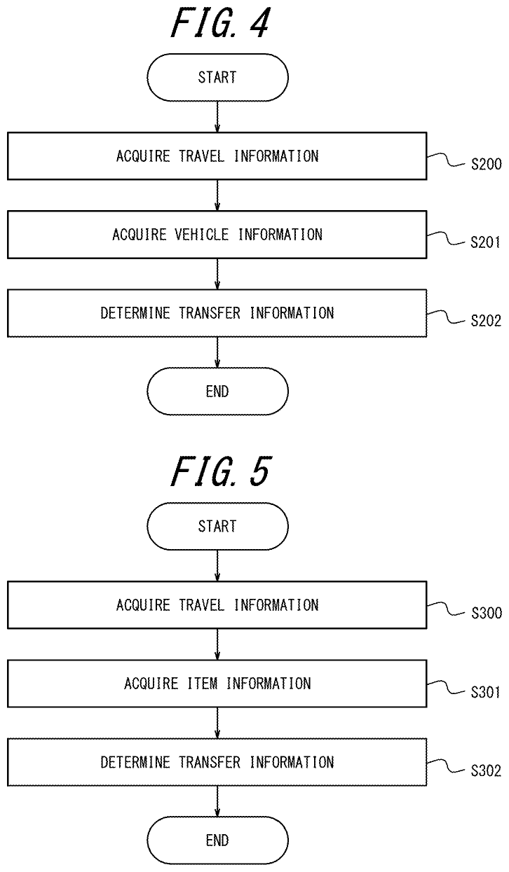

FIG. 4 is a flowchart illustrating a first example of an information processing method executed by the information processing apparatus 10 of FIG. 1. The flowchart in FIG. 4 illustrates the flow of processing when the controller 13 of the information processing apparatus 10 uses both the travel information and the vehicle information to determine the transfer information.

In step S200, the controller 13 of the information processing apparatus 10 acquires travel information including the travel route when the vehicle 20 travels. For example, the controller 13 receives the travel information from the vehicle 20 via the network 50 and the communication interface 11.

In step S201, the controller 13 acquires vehicle information for the vehicle 20. For example, the controller 13 receives the vehicle information for the vehicle 20 from the vehicle 20 via the network 50 and the communication interface 11.

In step S202, the controller 13 determines the transfer information based on the travel information acquired in step S200 and the vehicle information acquired in step S201.

FIG. 5 is a flowchart illustrating a second example of an information processing method executed by the information processing apparatus 10 of FIG. 1. The flowchart in FIG. 5 illustrates the flow of processing when the controller 13 of the information processing apparatus 10 uses both the travel information and the item information for the delivery item to determine the transfer information.

In step S300, the controller 13 of the information processing apparatus 10 acquires the travel information including a travel route for when the vehicle 20 travels. For example, the controller 13 receives the travel information from the vehicle 20 via the network 50 and the communication interface 11.

In step S301, the controller 13 acquires the item information for the delivery item. For example, the controller 13 receives the item information for the delivery item from the terminal apparatus 30 via the network 50 and the communication interface 11.

In step S302, the controller 13 determines the transfer information based on the travel information acquired in step S300 and the item information for the delivery item acquired in step S301.

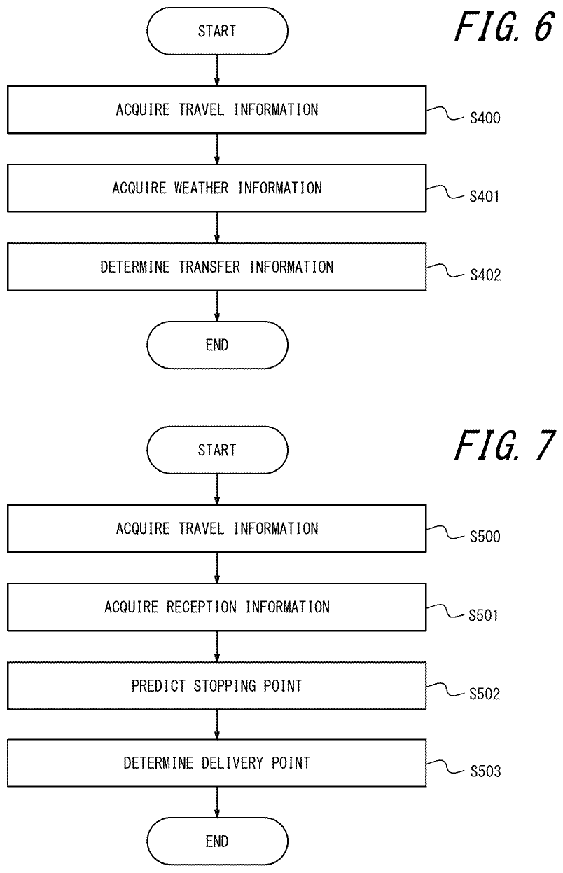

FIG. 6 is a flowchart illustrating a third example of an information processing method executed by the information processing apparatus 10 of FIG. 1. The flowchart in FIG. 6 illustrates the flow of processing when the controller 13 of the information processing apparatus 10 uses both the travel information and weather information on the travel route to determine the transfer information.

In step S400, the controller 13 of the information processing apparatus 10 acquires the travel information including a travel route for when the vehicle 20 travels. For example, the controller 13 receives the travel information from the vehicle 20 via the network 50 and the communication interface 11.

In step S401, the controller 13 acquires weather information on the travel route included in the travel information acquired in step S400. For example, the controller 13 receives such weather information from any appropriate external apparatus via the network 50 and the communication interface 11.

In step S402, the controller 13 determines the transfer information based on the travel information acquired in step S400 and the weather information acquired in step S401.

FIG. 7 is a flowchart illustrating a fourth example of an information processing method executed by the information processing apparatus 10 of FIG. 1. The flowchart in FIG. 7 illustrates a more specific processing flow when the controller 13 of the information processing apparatus 10 determines the delivery point included in the transfer information.

In step S500, the controller 13 of the information processing apparatus 10 acquires the travel information including a travel route for when the vehicle 20 travels. For example, the controller 13 receives the travel information from the vehicle 20 via the network 50 and the communication interface 11.

In step S501, the controller 13 acquires the reception information. For example, the controller 13 receives the reception information from the terminal apparatus 30 via the network 50 and the communication interface 11.

In step S502, the controller 13 predicts a stopping point at which the vehicle 20 temporarily stops based on the travel information acquired in step S500. For example, the controller 13 may acquire the traffic information along the travel route included in the travel information from the vehicle 20 or any appropriate external apparatus and may predict a point at which the vehicle 20 is estimated to stop temporarily due to a traffic jam as a stopping point. For example, in conjunction with the travel route included in the travel information, the controller 13 may acquire placement information on traffic signals along the travel route from the vehicle 20 or from any appropriate external apparatus. Based on such placement information on traffic signals, the controller 13 may predict a point at which the vehicle 20 is estimated to stop temporarily due to the red light as a stopping point.

In step S503, the controller 13 determines a delivery point included in the transfer information. For example, the controller 13 may determine the delivery point based on the point at which the unmanned aircraft 40 begins the delivery of the delivery item, i.e., the reception point included in the reception information acquired in step S501, and the travel information acquired in step S500. For example, the controller 13 may determine a point that is an intermediate point between the reception point and the point where the vehicle 20 is currently located and that is located on the travel route as the delivery point. For example, the controller 13 may determine the stopping point predicted in step S502 as the delivery point.

These examples are not limiting, and the controller 13 may determine the delivery point based not only on the travel route and the current positional information for the vehicle 20, but also on the travel speed of the vehicle 20 included in the travel information. For example, if the controller 13 judges that the travel speed of the vehicle 20 is sufficiently faster than the flight speed of the unmanned aircraft 40, the controller 13 may determine a point that is on the travel route but is farther towards the reception point than the above-described intermediate point as the delivery point. For example, if the controller 13 judges that the travel speed of the vehicle 20 is sufficiently slower than the flight speed of the unmanned aircraft 40, the controller 13 may determine a point that is on the travel route but is farther towards the current position of the vehicle 20 than the above-described intermediate point as the delivery point.

In step S503, the controller 13 may determine a scheduled delivery time included in the transfer information in addition to the delivery point. For example, the controller 13 may determine, as the scheduled delivery time, a time that is later than the available reception time included in the reception information by the travel time for the unmanned aircraft 40 to travel from the reception point to the delivery point.

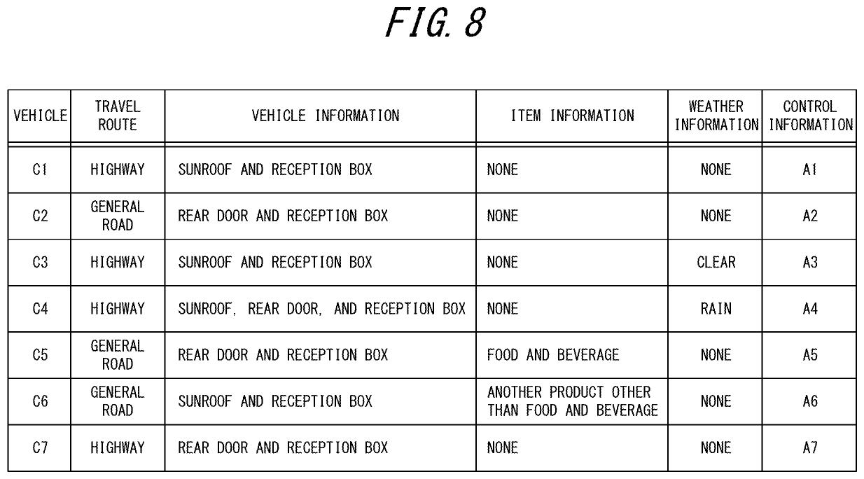

FIG. 8 is a diagram illustrating an example of processing by the controller 13 of the information processing apparatus 10 of FIG. 2. Referring to FIG. 8, a process executed by the controller 13 to determine the transfer information will be described in more detail. In FIG. 8, a specific example is given for seven vehicles C1 through C7, but the number of vehicles 20 for which the controller 13 determines the transfer information is not limited to seven.

The controller 13 acquires, from the vehicle C1, information indicating a highway as the travel route for the vehicle C1 to travel. Additionally, the controller 13 acquires information indicating that the vehicle C1 has a sunroof and a reception box as the vehicle information for the vehicle C1. At this time, the controller 13 determines control information A1 included in the transfer information taking into consideration that it is difficult for the vehicle C1 to stop temporarily when traveling on a highway. The control information A1 includes control information for the unmanned aircraft 40 and control information for the vehicle C1 so that the unmanned aircraft 40 flies in parallel with the vehicle C1 while the vehicle C1 is traveling on the highway and places the delivery item into the cabin of the vehicle C1. For example, based on such control information, the controller 26 of the vehicle C1 opens the sunroof of the vehicle C1 when the unmanned aircraft 40 is flying in parallel with the vehicle C1. For example, based on such control information, the controller 45 of the unmanned aircraft 40 controls the conveyor 44 to place the delivery item into the reception box, positioned below the open sunroof, of the vehicle C1.

The controller 13 acquires, from the vehicle C2, information indicating a general road as the travel route for the vehicle C2 to travel. Additionally, the controller 13 acquires, as vehicle information for the vehicle C2, information indicating that the vehicle C2 has a door and a reception box at the rear. At this time, the controller 13 determines control information A2 included in the transfer information taking into consideration that it is easy for the vehicle C2 to stop temporarily when traveling on a general road. The control information A2 includes, for example, control information for the unmanned aircraft 40 and control information for the vehicle C2 for the unmanned aircraft 40 to place the delivery item into the cabin of the vehicle C2 while the vehicle C2 is temporarily stopped at the delivery point determined in step S503 of FIG. 7, described above. For example, based on such control information, the controller 26 of the vehicle C2 temporarily stops the vehicle C2 at the determined delivery point and opens the door at the rear of the vehicle C2. For example, based on such control information, the controller 45 of the unmanned aircraft 40 controls the conveyor 44 to place the delivery item into the reception box of the vehicle C2 located adjacent to the open rear door.

The controller 13 acquires, from the vehicle C3, information indicating a highway as the travel route for the vehicle C3 to travel. Additionally, the controller 13 acquires information indicating that the vehicle C3 has a sunroof and a reception box as the vehicle information for the vehicle C3. Additionally, the controller 13 acquires information indicating clear weather as the weather information on the travel route. At this time, the controller 13 determines control information A3 included in the transfer information taking into consideration that it is difficult for the vehicle C3 to stop temporarily when traveling on a highway, and that opening the sunroof of the vehicle C3 during travel is not problematic. The control information A3 is identical to the control information A1, except that the target vehicle 20 is changed from the vehicle C1 to the vehicle C3.

The controller 13 acquires, from the vehicle C4, information indicating a highway as the travel route for the vehicle C4 to travel. Additionally, the controller 13 acquires, as vehicle information for the vehicle C4, information indicating that the vehicle C4 has a sunroof and has a door and a reception box at the rear. Additionally, the controller 13 acquires information indicating rain as the weather information on the travel route. At this time, the controller 13 determines control information A4 included in the transfer information taking into consideration that it is difficult for the vehicle C4 to stop temporarily when traveling on a highway, and that opening the sunroof of the vehicle C4 during travel is problematic, since rain would get inside the vehicle. The control information A4 includes control information for the unmanned aircraft 40 and control information for the vehicle C4 for the unmanned aircraft 40 to place the delivery item into the cabin of the vehicle C4 while the vehicle C4 is temporarily stopped at a predetermined service area along the travel route. For example, based on such control information, the controller 26 of the vehicle C4 temporarily stops the vehicle C4 in the predetermined service area and opens the door at the rear of the vehicle C4. For example, based on such control information, the controller 45 of the unmanned aircraft 40 controls the conveyor 44 to place the delivery item into the reception box of the vehicle C4 located adjacent to the open rear door.

The controller 13 acquires, from the vehicle C5, information indicating a general road as the travel route for the vehicle C5 to travel. Additionally, the controller 13 acquires, as vehicle information for the vehicle C5, information indicating that the vehicle C5 has a door and a reception box at the rear. Additionally, the controller 13 acquires item information, for the delivery item, regarding food and beverage from the terminal apparatus 30. At this time, the controller 13 determines control information A5 included in the transfer information taking into consideration that it is easy for the vehicle C5 to stop temporarily when traveling on a general road, and that stable transfer is required due to the nature of the delivery item, which is food and beverage. The control information A5 is identical to the control information A2, except that the target vehicle 20 is changed from the vehicle C2 to the vehicle C5.

The controller 13 acquires, from the vehicle C6, information indicating a general road as the travel route for the vehicle C6 to travel. Additionally, the controller 13 acquires information indicating that the vehicle C6 has a sunroof and a reception box as the vehicle information for the vehicle C6. Additionally, the controller 13 acquires item information, for the delivery item, regarding another product other than food and beverage from the terminal apparatus 30. At this time, the controller 13 determines control information A6 included in the transfer information taking into consideration that it is easy for the vehicle C6 to stop temporarily when traveling on a general road, but that transfer during travel is not problematic due to the nature of the delivery item, which is another product other than food and beverage. The control information A6 includes control information for the unmanned aircraft 40 and control information for the vehicle C6 so that the unmanned aircraft 40 flies in parallel with the vehicle C6 while the vehicle C6 is traveling on the general road and places the delivery item into the cabin of the vehicle C6. For example, based on such control information, the controller 26 of the vehicle C6 opens the sunroof of the vehicle C6 when the unmanned aircraft 40 is flying in parallel with the vehicle C6. For example, based on such control information, the controller 45 of the unmanned aircraft 40 controls the conveyor 44 to place the delivery item into the reception box, positioned below the open sunroof, of the vehicle C6.

The controller 13 acquires, from the vehicle C7, information indicating a highway as the travel route for the vehicle C7 to travel. Additionally, the controller 13 acquires, as vehicle information for the vehicle C7, information indicating that the vehicle C7 does not have a sunroof but has a door and a reception box at the rear. At this time, the controller 13 determines control information A7 included in the transfer information taking into consideration that it is difficult for the vehicle C7 to stop temporarily when traveling on a highway, and that transfer during travel is problematic, since the vehicle C7 does not have a sunroof. The control information A7 is identical to the control information A4, except that the target vehicle 20 is changed from the vehicle C4 to the vehicle C7.

According to the above embodiment, a user on board the traveling vehicle 20 can receive a delivery item from the unmanned aircraft 40. For example, based on the acquired travel information for the vehicle 20, the information processing apparatus 10 determines transfer information for when the delivery item, to be delivered by the unmanned aircraft 40 to the user on board the vehicle 20, is transferred to the user. This enables a user to receive a necessary delivery item not only at a location with fixed positional information, such as at home, but also along a travel route of the vehicle 20 in which the user is riding. This improves the convenience for users of the information processing system 1.

By determining the transfer information based on the acquired vehicle information, the information processing apparatus 10 can appropriately determine the transfer information in accordance with the vehicle information for the vehicle 20. For example, the information processing apparatus 10 can appropriately determine the control information for the unmanned aircraft 40 and/or the control information for the vehicle 20 based on the detailed structural information on the vehicle body. The information processing apparatus 10 can cause the unmanned aircraft 40 to perform a transfer method adapted to the structure of the body of the vehicle 20.

By determining the transfer information based on the acquired item information for the delivery item, the information processing apparatus 10 can appropriately determine the transfer information in accordance with the item information for the delivery item. For example, the information processing apparatus 10 can appropriately determine the control information for the unmanned aircraft 40 and/or the control information for the vehicle 20 in accordance with whether the delivery item is a food or beverage. The information processing apparatus 10 can cause the unmanned aircraft 40 to perform a transfer method adapted to the type of delivery item.

By determining the transfer information based on the acquired weather information, the information processing apparatus 10 can appropriately determine the transfer information in accordance with the weather information on the travel route when the vehicle 20 is traveling. For example, the information processing apparatus 10 can appropriately determine the control information for the unmanned aircraft 40 and/or the control information for the vehicle 20 based on the weather conditions along the travel route. The information processing apparatus 10 can cause the unmanned aircraft 40 to perform a transfer method adapted to the weather conditions along the travel route.

The information processing apparatus 10 determines a delivery point included in the transfer information based on the point at which the unmanned aircraft 40 starts delivery of the delivery item and the travel information. As a result, the information processing apparatus 10 can flexibly determine an appropriate delivery point in accordance with the reception point of the delivery item by the unmanned aircraft 40 and the travel information. For example, the information processing apparatus 10 can easily determine a delivery point that conforms to the reception point of the delivery item by the unmanned aircraft 40 and the travel route and current positional information for the vehicle 20, and that is favorable for both the unmanned aircraft 40 and the vehicle 20. Additionally, the information processing apparatus 10 can easily determine a delivery point that is more favorable for the vehicle 20 by determining the delivery point in consideration also of the travel speed of the vehicle 20.

By determining the predicted stopping point as the delivery point included in the transfer information, the information processing apparatus 10 can stably transfer the delivery item by the unmanned aircraft 40 when the vehicle 20 temporarily stops due to, for example, a traffic jam or a red light. This enables a user on board the vehicle 20 to stably receive a delivery item from the unmanned aircraft 40 when the vehicle 20 is temporarily stopped.

The information processing apparatus 10 determines control information for the unmanned aircraft 40 included in the transfer information so that the unmanned aircraft 40 flies in parallel with the vehicle 20 while the vehicle 20 is traveling and places the delivery item into the cabin of the vehicle 20. As a result, the information processing apparatus 10 can cause the unmanned aircraft 40 to transfer the delivery item without the need to temporarily stop the vehicle 20 when the vehicle 20 is traveling. This enables a user on board the vehicle 20 to receive a delivery item from the unmanned aircraft 40 even while the vehicle 20 is traveling. The convenience for the user with regard to delivery of delivery items therefore improves.

While the present disclosure has been described with reference to the drawings and examples, it should be noted that various modifications and revisions can be implemented by those skilled in the art based on the present disclosure. Accordingly, such modifications and revisions are included within the scope of the present disclosure. For example, functions or the like included in each configuration, each step, or the like can be rearranged without logical inconsistency, and a plurality of configurations, steps, or the like can be combined into one or divided.

For example, in the above embodiment above, at least a portion of the processing operations executed in the information processing apparatus 10 may be executed in the vehicle 20, the terminal apparatus 30, and/or the unmanned aircraft 40. For example, instead of the information processing apparatus 10, the vehicle 20 itself may execute the processing operations described above with regard to the information processing apparatus 10. At least a portion of the processing operations executed in the vehicle 20, the terminal apparatus 30, and/or the unmanned aircraft 40 may be executed on the information processing apparatus 10.

For example, a configuration that causes a general purpose electronic device such as a smartphone, a computer, or the like to function as the information processing apparatus 10 according to the above embodiment is possible. Specifically, a program in which processes for realizing the functions of the information processing apparatus 10 or the like according to the embodiment are written may be stored in a memory of the electronic device, and the program may be read and executed by a processor of the electronic device. Accordingly, in an embodiment, the present disclosure can also be implemented as a program executable by a processor.

Alternatively, the disclosure according to an embodiment can also be implemented as a non-transitory computer readable medium storing a program executable by a single processor or a plurality of processors to cause the information processing apparatus 10 or the like according to the embodiment to execute the functions. It is to be understood that these are also included within the scope of the present disclosure.

For example, the information processing apparatus 10 described in the above embodiment may be mounted in the vehicle 20. In this case, the information processing apparatus 10 may directly communicate information with the vehicle 20 without using the network 50.

In the above embodiment, the information processing apparatus 10 has been described as acquiring order information for a delivery item from the vehicle 20, but this example is not limiting. For example, the information processing apparatus 10 may acquire a request, from the vehicle 20, to receive a delivery item sent from any sender as an express package to a user on board the vehicle 20. Such order information or reception request has been described as being acquired and transmitted to the information processing apparatus 10 by the vehicle 20, but this example is not limiting. For example, any terminal apparatus managed by the user may acquire and transmit such an order information or reception request to the information processing apparatus 10. In this case, the information processing system 1 may include the terminal apparatus managed by the user.

In the above embodiment, the information processing apparatus 10 has been described as determining a point located on the travel route as a delivery point, but this example is not limiting. The delivery point need not be on the travel route.

In the above embodiment, the information processing system 1 has been described as including the information processing apparatus 10, the vehicle 20, the terminal apparatus 30, and the unmanned aircraft 40, but this example is not limiting. The information processing system 1 need not include the terminal apparatus 30.

In the above embodiment, the vehicle 20 has been described as controlling the sunroof or the rear door of the vehicle 20 for transfer of the delivery item from the unmanned aircraft 40, but this example is not limiting. The vehicle 20 may control side windows and the like instead of, or in addition to, the sunroof and the rear door.

In the above embodiment, transfer of a delivery item has been described as being performed based on control of both the vehicle 20 and the unmanned aircraft 40, but this example is not limiting. For example, when the vehicle 20 is a convertible or a truck with a cargo bed, the unmanned aircraft 40 alone may be controlled so that the delivery item is placed on a seat of the convertible or the cargo bed of the truck.

1. An information processing apparatus comprising a controller configured to:
acquire travel information including a travel route for when a vehicle travels, and determine, based on the acquired travel information, transfer information for when a delivery item to be delivered by an unmanned aircraft to a user on board the vehicle is transferred to the user.

2. The information processing apparatus of claim 1, wherein the controller is configured to acquire vehicle information for the vehicle and determine the transfer information based on the acquired vehicle information.

3. The information processing apparatus of claim 1, wherein the controller is configured to acquire item information for the delivery item and determine the transfer information based on the acquired item information.

4. The information processing apparatus of claim 1, wherein the controller is configured to acquire weather information on the travel route and determine the transfer information based on the acquired weather information.

5. The information processing apparatus of claim 1, wherein the controller is configured to determine a delivery point included in the transfer information based on a point at which the unmanned aircraft starts delivery of the delivery item and on the travel information.

6. The information processing apparatus of claim 1, wherein the controller is configured to predict a stopping point at which the vehicle temporarily stops based on the acquired travel information and determine the predicted stopping point as a delivery point included in the transfer information.

7. The information processing apparatus of claim 1, wherein the controller is configured to determine control information for the unmanned aircraft included in the transfer information so that the unmanned aircraft flies in parallel with the vehicle while the vehicle is traveling and places the delivery item in a cabin of the vehicle.

8. An information processing system comprising: the information processing apparatus of claim 1; the vehicle configured to provide the travel information to the information processing apparatus; and the unmanned aircraft configured to deliver the delivery item to the user on board the vehicle.

9. A non-transitory computer readable medium storing a program executable by one or more processors to cause an information processing apparatus to execute functions comprising:
acquiring travel information including a travel route for when a vehicle travels; and
determining, based on the acquired travel information, transfer information for when a delivery item to be delivered by an unmanned aircraft to a user on board the vehicle is transferred to the user.

10. The non-transitory computer readable medium of claim 9, wherein the functions further comprise acquiring vehicle information for the vehicle and determining the transfer information based on the acquired vehicle information.

11. The non-transitory computer readable medium of claim 9, wherein the functions further comprise acquiring item information for the delivery item and determining the transfer information based on the acquired item information.

12. The non-transitory computer readable medium of claim 9, wherein the functions further comprise acquiring weather information on the travel route and determining the transfer information based on the acquired weather information.

13. The non-transitory computer readable medium of claim 9, wherein the functions further comprise determining a delivery point included in the transfer information based on a point at which the unmanned aircraft starts delivery of the delivery item and on the travel information.

14. The non-transitory computer readable medium of claim 9, wherein the functions further comprise predicting a stopping point at which the vehicle temporarily stops based on the acquired travel information and determining the predicted stopping point as a delivery point included in the transfer information.

15. A vehicle comprising a controller configured to:
acquire travel information including a travel route for when the vehicle travels, and determine, based on the acquired travel information, transfer information for when a delivery item to be delivered by an unmanned aircraft to a user on board the vehicle is transferred to the user.

16. The vehicle of claim 15, wherein the controller is configured to acquire vehicle information for the vehicle and determine the transfer information based on the acquired vehicle information.

17. The vehicle of claim 15, wherein the controller is configured to acquire item information for the delivery item and determine the transfer information based on the acquired item information.

18. The vehicle of claim 15, wherein the controller is configured to acquire weather information on the travel route and determine the transfer information based on the acquired weather information.

19. The vehicle of claim 15, wherein the controller is configured to determine a delivery point included in the transfer information based on a point at which the unmanned aircraft starts delivery of the delivery item and on the travel information.

20. The vehicle of claim 15, wherein the controller is configured to predict a stopping point at which the vehicle temporarily stops based on the acquired travel information and determine the predicted stopping point as a delivery point included in the transfer information.
